(19) United States
(12) Patent Application Publication
(10) Pub. No.: US 2004/0205212 A1
(43) Pub. Date: Oct. 14, 2004

(54) Method and system for forwarding a service-related information to a network user

(75) Inventors: Seppo Huotari, Espoo (FI); Kirsi Rotsten, Espoo (FI); Markku Tuohino, Espoo (FI); Simo Hyytia, Espoo (FI); Georg Mayer, Espoo (FI); Markus Isomaki, Espoo (FI); Jarmo Kuusinen, Jyvaskyla (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/787,974

(22) Filed: Feb. 27, 2004

(30) Foreign Application Priority Data
Mar. 31, 2003 (EP) 03007278.9

(51) Int. Cl. G06F 15/16

(52) U.S. Cl. 709/230; 709/228

(57) ABSTRACT

A method and system forwards a service-related information to network user, wherein at least one new event package directed to a service configuration and/or a de-registration state of the network user is provided at a session control device or a default server or an application server, respectively. A terminal device of the network user initiates a subscription to the new event package. In response thereto, a notification informing about the service configuration and/or the de-registration state of the network user is generated and routed to the terminal device to be made available to the network user.

### BACKGROUND OF THE INVENTION

1. Field of the Invention

The present invention relates to a method and system for forwarding a service-related information, for instance, a service configuration, to a network user such as a subscriber in an Internet Protocol Multimedia Subsystem (IMS).

2. Description of the Related Art

In order to achieve access independence and to maintain a smooth interoperation with wired terminals across the Internet, the IMS as specified, for example, in the 3GPP specifications TS 23.228, 24.228, 24.229 and 23.218, has been developed to be conformant to IETF (Internet Engineering Task Force) “Internet Standards”. The IP multimedia core network (IM CN) subsystem enables network operators of mobile or cellular networks to offer their subscribers multimedia services based on and built upon Internet applications, services and protocols. The intention is to develop such services by mobile network operators and other third party suppliers including those in the Internet space using the mechanisms provided by the Internet and the IM CN subsystem. The IMS thus enables conversions of, and access to, voice, video, messaging, data and web-based technologies for wireless users, and combines the growth of the Internet with the growth in mobile communications.

FIG. 1 shows an architecture of an IMS network according to the above 3GPP (Third Generation Partnership Project) specification. The architecture is based on the principle that the service control for home subscribed services for a roaming subscriber is in the home network HN, e.g. a Serving Call State Control Function (S-CSCF) is located in the home network HN. In FIG. 1, an S-CSCF 10 is shown, which currently controls or serves a terminal device or user equipment (UE) 40 according to the subscriber profile or network coverage of the UE 40.

In general, an S-CSCF performs the session control service for the served UEs. It maintains a session state as needed by the network operator for support of the services which may be provided by an application server (AS) 60 which may be located in an external network or in the home network HN or a visited network VN of the UE 40. Within an operator's network, different S-CSCFs may have different functionalities. The functions performed by the S-CSCF during a respective session are e.g. registration, session flow management, charging and resource utilization management. When a subscriber roams to the visited network VN, the visited network VN supports a Proxy-CSCF (P-CSCF) 30 which enables the session control to be passed to the respective S-CSCF located at the home network HN and providing the service control. Furthermore, an Interrogating-CSCF (I-CSCF) 50 is provided in the home network HN as a contact point within the operator's network for all connections destined to a subscriber of that network operator, or a roaming subscriber currently located within that network operator's service area. There may be multiple I-CSCFs within an operator's network. The functions performed by the I-CSCF 50 include assigning an S-CSCF to a user performing a registration procedure, routing a request received from another network towards the assigned S-CSCF, obtaining the address of an S-CSCF from a subscriber database, e.g. a Home Subscriber Server (HSS) 20 as shown in FIG. 1, and/or forwarding requests or responses to the S-CSCF based on the address obtained from the HSS 20.

The P-CSCF 30 is the first contact point within the IMS. Its address is discovered by the UE 40 following a PDP (Packet Data Protocol) context activation. The P-CSCF 30 behaves like a proxy by accepting requests and services internally or forwarding them on, possibly after translation. The P-CSCF 30 may also behave as a User Agent so that in abnormal conditions it may terminate and independently generate transactions. The functions performed by the P-CSCF 30 are forwarding register requests received from the UE 40 to an I-CSCF, e.g. the I-CSCF 50, determined using the home domain name as provided by the UE 40, and forwarding requests or responses to the UE 40.

Further details regarding the functions of the different CSCF elements shown in FIG. 1 can be gathered from the above mentioned 3GPP-specifications.

SIP (Session Initiation Protocol) is defined in the IETF (Internet Engineering Task Force) specification RFC 3161. It is a protocol allowing establishment, handling and release of end-to-end multimedia sessions. There are several additions to the SIP protocol, which allow event notification based on SIP, which is the basis for a SIP based Presence Service and other services.

The document identified as draft-rosenberg-sipping-conferencing-framework-01 (“Framework Draft”), herein incorporated by reference, describes a framework for the SIP conferences. Furthermore, the document identified as draft-johnston-sipping-cc-conferencing-01 (“Johnston Draft”), herein incorporated by reference, describes in more detail how SIP conferences can be created.

The IETF has been specifying a Session Initiation Protocol (SIP) event package for registrations, as defined in the RFC 3680, herein incorporated by reference. Through its REGISTER method, SIP allows a user agent, which is an interface (e.g. browser) between the user and the network application, to create, modify, and delete registrations. Registrations can also be altered by administrators in order to enforce policy. As a result, these registrations represent a piece of state in the network that can change dynamically. There are many cases where a user agent would like to be notified of changes in this state. The event package defines a mechanism by which those user agents can request and obtain such notifications.

The SIP REGISTER method provides a way for a user agent to manipulate registrations. Contacts can be added or removed, and the current set of contacts can be queried. Registrations can also change as a result of administrator policy. For example, if a user is suspected of fraud, his registration can be deleted so that they cannot receive any requests. Registrations also expire after some time if not refreshed. Thus, registrations represent a dynamic piece of state maintained by the network.

The SIP Events Framework defines a generic framework for subscription to, and notification of, events related to SIP systems. The framework is described in the IETF specification RFC 3265 and defines the methods SUBSCRIBE and NOTIFY, and introduces the notion of a package. A package is a concrete application of the event framework to a particular class of events, e.g. registration states. The SUBSCRIBE message for the registration package may contain a body for filtering the subscription. It may be sent with or without the body. The default registration policy is that notifications are triggered from a SUBSCRIBE message and are generated every time there is a change in the state of any of the registered contacts for the resource being subscribed to. Those notifications only contain information on the contacts whose state has changed. The notifications are forwarded using the NOTIFY message included in its body. In the notification, a registration information document describes some or all of the contacts associated with a particular address-of-record.

In the 3GPP IMS Release 5 specifications TS 24.229, 24.228 and 23.218, the SIP registration state event package is used to inform the subscribers of the event package about the user's registration state. The functionality of this event is located in the S-CSCF. 3GPP IMS Release 6 will introduce new services to the system, such as Presence, Messages, Conferencing and MMS. According to the IMS Release 5 specifications, the IMS subscriber is either registered or deregistered.

IMS users need to get aware of service-specific configurations upon registration to the IMS network. Possible service configurations can be the Presence server assigned to the user, the MRFC assigned to the user for means of conferences, and/or other application servers which the user specifically needs to contact, e.g. by means of event subscriptions, specific URIs (Uniform Resource Indicators) that the users needs to register if the user wants to receive the benefit of a specific service, e.g. a Push to Talk over Cellular (POC) service.

So far, service parameters have been transferred in a SIP header e.g. in the Request-URI header of a SIP message, e.g. “abc@xyz.com; service=poc”, which however is not an IEIT compliant solution, or in a Session Description Protocol (SDP) payload. Additionally, a routing magic may be provided, such as “if XYZ header is there then send this to ABC, although the Request-URI header indicates LMAA”. Furthermore, the parameters may be pre-configured at the UE. However, in this case, the configuration effort is much too high and the static configuration is not flexible enough.

It is expected that there will be many types of ASs connected to the IMS system, one example being a Push-To-Talk (PTT) or Push-over-Cellular (POC) AS. IMS will provide the AS's capabilities that can be used to implement services to the subscribers. These capabilities include, for example, third party registration from IMS towards the AS. In the third party registration, which is specified in the above 3GPP specifications, the registration towards the AS basically is just a notification that the registration in IMS has happened. However, it is not possible for the AS to start de-registration of the subscriber or even a specific Public User Identity allocated to the subscriber. There is no mechanism provided, by which the external AS can ask or request the UE to deregister. The AS can deny the third party registration. If the AS is then classified as critical, this should lead to the deregistration. Nevertheless, this requires that the registration is passed to the AS. It cannot actively start the deregistration procedure.

### SUMMARY OF THE INVENTION

The invention provides a method, system and network device, by means of which a network user can be notified of a service configuration and/or a de-registration intent of an AS.

The invention provides a method of forwarding a service-related information from an IP-based network to a network user. The method includes the steps of:

providing at the IP-based network a first event package directed to a service configuration and/or at an application server a second event package directed to a de-registration state of the network user;

initiating a subscription of the network user to the first and/or second service-related event package; and

transmitting a notification informing about the service configuration and/or the de-registration from the IP-based network and/or the application server to the network user in response to the subscription initiation.

Furthermore, the invention provides a network device for serving a network user in a data network. The network device is configured to store an event package directed to a service configuration of the network user, and to transmit a notification with a service configuration information towards the network user in response to a subscription of the network user to the service configuration event package.

Additionally, the invention seeks to provide an application server for providing at least one service application to a network user. The application server is configured to offer at least one event package directed to a service configuration and/or a de-registration state of the network user, and to forward a notification informing about the service configuration and/or the de-registration towards the network user in response to a subscription of the network user to the at least one event package.

Moreover, a terminal device provides a connection to a service application of an IP-based network. The terminal device is configured to initiate a subscription to at least one event package directed to a service configuration of the terminal device and/or a de-registration state in response to a successful registration to the IP-based network.

Accordingly, at least one new event package is introduced which is provided to offer configuration of multiple services to the terminal device of a network user without requiring any pre-configuration at the terminal device for these services. Another advantage is given in that a new event package at the application server enables active de-registration of a subscriber or a specific public user identity by the application server. Based on the AS-specific event package, the network user can be informed if some specific event happens which requires the terminal device to be de-registered.

The new service configuration event package may be offered by a session control device assigned to a terminal device of the network user, wherein the subscription is initiated by the terminal device to the session control device, e.g. an S-CSCF of an IMS network. This provides the advantage that the service configuration of the network user can be downloaded from a subscriber database via the usually available interface between the session control device and the subscriber database. In addition thereto, the network user does not need any pre-configured URI for this event package.

As an alternative, the service configuration event package may be offered by a default server, wherein the subscription is again initiated by the terminal device of the network user to the default server.

In general, the initiation process can be performed after a successful registration procedure of the terminal device of the network user.

The received service-related information can be stored at the terminal device to allow the network user to make use of the service-related information.

The de-registration event package may be provided at an application server, wherein the subscription is initiated to the application server. Then, the SUBSCRIBE request may be subjected to at least one filter criterion at a session control device. Thereby, the session control device, e.g. S-CSCF, is able to control or restrict the forwarding of SUBSCRIBE requests. The de-registration notification may be transmitted from the application server towards the terminal device of the network user in response to the occurrence of a specific event at the application server. This specific event may have been caused as a result of a failure situation or an exceeding of a prepaid account. As an example, the application server may be a Push To Talk (PTT) or Push-over-Cellular (POC) server.

The terminal device may be configured to determine whether the subscriber has stored only one user identity, and to reject a forced deregistration of the subscriber or of a specific user identity in response to the determination result. Then, the terminal device may be configured to hide the user identity or identities in response to the forced deregistration. Thereby, the subscriber or user still has access to the service, even if a forced deregistration occurs while there is only one user identity registered or there are only implicitly registered user identities.

In all the above embodiments, the subscription may be initiated by forwarding a SIP SUBSCRIBE request from a terminal device of the network user towards the IP-based network. The notification is then transmitted to the network user in a SIP NOTIFY message. Hence, an easy and straight forward implementation is possible by using available SIP mechanisms.

### BRIEF DESCRIPTION OF THE DRAWINGS

In the following, the present invention will be described in greater detail based on preferred embodiments with reference to the accompanying drawings, in which:

FIG. 1 shows a schematic block diagram of a network architecture in which an embodiment of the invention can be implemented;

FIG. 2 shows a message signaling and processing diagram indicating a subscription procedure to a session control device according to a first embodiment;

FIG. 3 shows a message signaling and processing diagram indicating a subscription procedure to an application server according to a second embodiment; and

FIG. 4 shows a message signaling and processing diagram indicating an AS-specific forced deregistration with an enhanced terminal function according to a third embodiment

### DESCRIPTION OF THE PREFERRED EMBODIMENTS

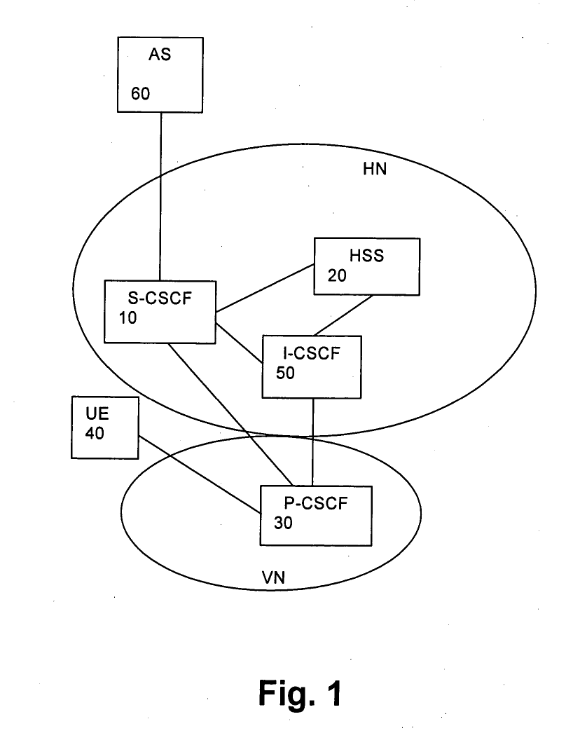

The preferred embodiments will now be described on the basis of an event package subscription in an IMS network architecture as shown in FIG. 1.

The IMS architecture shown in FIG. 1 refers to a set of core network entities using the services provided by the packet-switched domain to offer multimedia services. The HSS 20 is the master database for a given user and includes the functions of conventional home location registers (HLRs) as well as new functionalities specified to IP networks, such as the IMS. The HSS 20 is the entity containing the subscription-related information to support the network entities actually handling calls and/or sessions.

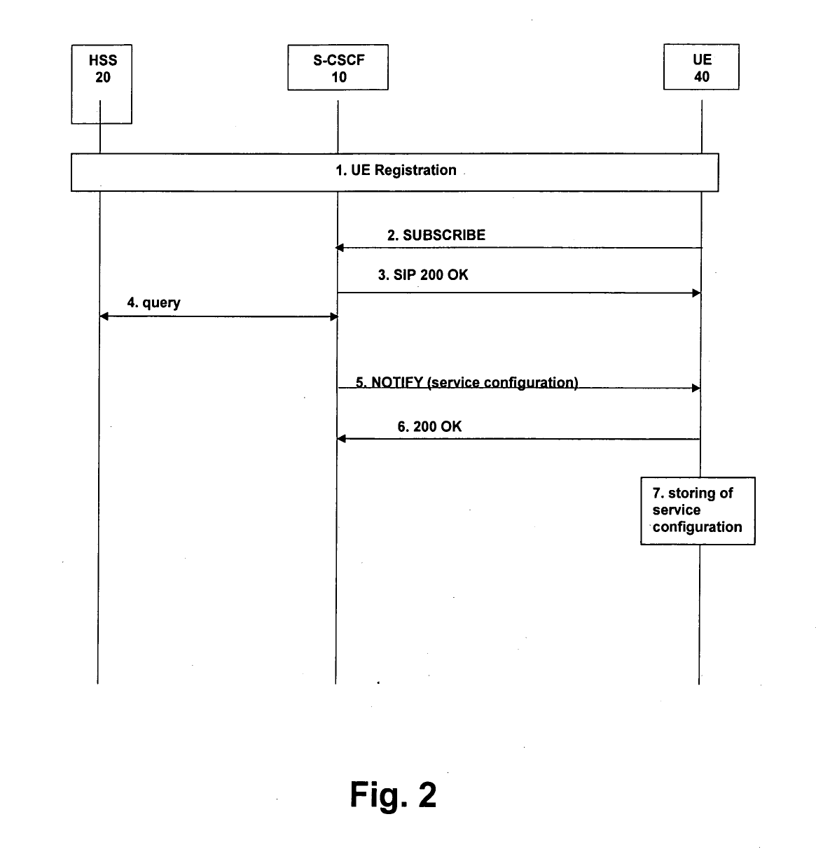

FIG. 2 shows a schematic signaling diagram according to a first embodiment of the invention where an IMS user can retrieve information about service specific configurations after registration to the IMS network.

Possible service configurations can include the Presence server assigned to the user, the MRFC (Media Resource Function Control) assigned to the user for conference purposes, and/or other ASs which the user specifically might need to contact, e.g. by means of event subscriptions, specific URIs the user needs to register if the user wants to receive the benefit of a specific service, e.g. a PTT or POC service.

According to the first preferred embodiment, the above service-related parameters can be kept updated at the user by having the UE 40 of the user subscribed to a new service configuration event package. This package is either offered by the S-CSCF 10 assigned to the user or by an AS. One advantage of putting this functionality to the S-CSCF 10 would be that the S-CSCF 10 can easily download the service configuration from the HSS 20 via the Cx interface. Furthermore, the UE 40 does not need any pre-configured URI for this event package.

According to FIG. 2, the UE 40 is first registered to the IMS network (step 1). After successful registration, the UE 40 subscribes to the new service configuration event package by forwarding a SIP SUBSCRIBE request for the new service configuration event package to the S-CSCF 10 in step 2.

The successful subscription is acknowledged by the S-CSCF 10 in step 3 with a SIP 200 “OK” response. Then, the S-CSCF 10 initiates a HSS query via the Cx interface in step 4 to thereby download the service configuration of the UE 40. The received current service configuration is then forwarded to the UE 40 in a SIP NOTIFY request in step 5. The UE 40 acknowledges the receipt by a SIP 200 “OK” response in step 6. Finally, in step 7, the UE 40 stores the received service configuration or uses it for an updating procedure of an earlier stored service configuration.

If the user or the UE 40 now wants to initiate one of the available services, for which specific configuration data has been retrieved, it can make use of the configuration data.

As a modification of the first embodiment, the functionality of the new service configuration event package may be provided at a default application server (not shown in FIG. 1). In this case, the UE 40 has available a pre-configured URI for routing the SIP SUBSCRIBE request to the default server.

As an example, the content of e.g. the NOTIFY request carrying the event package data in step 5 might be represented as follows:

<serviceinfo xmlns=″urn:ietf:params:xml:ns:serviceinfo″

version=″0″ state=″full″>

<service aor=″sip:poc-as.home1.net″ id=″a1 ″user=″sip:gema@poc.home1.net″

sblp=″applies″ media=″audio″ codec=″amr″>Push to talk over cellular

</service>
<service aor=″sip:conference-factory1@mrfc.home1.net″ id=″a2″

user=″sip:gema@home1.net″> Automatic conference creation

</service>
<service aor=″sip:mrfc1.home1.net″ id=″a3″ user=″sip:gema@home1.net″>

Conference Server

</service>
<service aor=″sip:gema@home1.net″ id=″a4″ user=″sip:gema@home1.net″>

Publish your own Presence Information

</service>

</serviceinfo>

As an alternative to the above example, multiple parameters may be provided for one service. Then, the following sub-structure can be used:

<service>

<server ...> ...
</server>

</service>

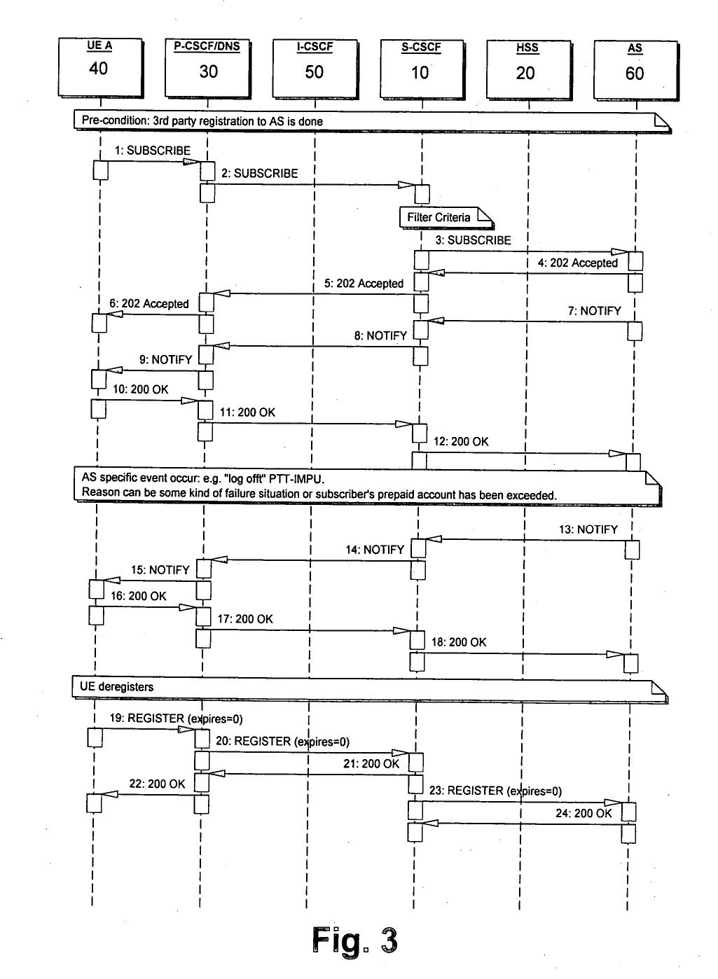

FIG. 3 shows a schematic signaling diagram according to the second embodiment of the invention, where the functionality of a new event package is provided at the AS 60 which provides at least one specific service application to the UE 40. The new AS specific event package can be used, for instance, to inform the use if some specific event happened, which requires de-registration of the UE 40.

According to the second embodiment, the AS 60 is able to actively de-register a subscriber or a public user identity.

As indicated in FIG. 3, a pre-condition of the procedure suggested in the second preferred embodiment is that the UE 40 has been subjected to a third party registration to the AS 60. After successful third party registration, The UE 40 forwards a SIP SUBSCRIBE request in steps 1 to 3 towards the AS 60 via the P-CSCF 30 and the S-CSCF 10. As an example, the AS specific event package may be related to a PTT or POC service, i.e. the notification message may provide in its payload portion the following content: “event=PTT service status” or “event=POC service status”. At the S-CSCF 10, predetermined filter criteria may be applied to filter out undesired or unsuccessful requests. Thereby, a control function is provided at the S-CSCF 10, by which it can be controlled to which AS specific event packages subscription is allowed.

After successful subscription, the AS 60 acknowledges the subscription by a SIP 202 “Accepted” acknowledgement routed via the S-CSCF 10 and the P-CSCF 30 to the UE 40 in steps 4 to 6. Then, the AS 60 immediately issues a SIP NOTIFY request including the current state of the event package in its payload portion, e.g. “state=active, event=logon”, via the S-CSCF 10 and the P-CSCF 30 to the UE 40 in steps 7 to 9. The receipt of the NOTIFY request is acknowledged by the UE 40 with a SIP 200 “OK” response in steps 10 to 12.

At a later point in time, the AS 60 may deny the service for the subscriber having an AS specific public user identity (IMPU) e.g. due to some kind of failure situation or due to the fact that the subscriber's prepaid account has been expired. This may be interpreted at the AS 60 as the occurrence of an AS specific event, e.g. “log off” PTT-IMPU. In response to the occurrence of the AS specific event, the AS 60 informs the UE 40 by sending a new SIP NOTIFY request with a new state information in its payload portion, e.g. “state=terminated, event=logoff”, via the S-CSCF 10 and the P-CSCF 30 to the UE 40 in steps 13 to 15. In steps 16 to 18, the UE 40 acknowledges receipt of the notification by responding with a SIP 200 “OK” message.

The received new state information initiates a de-registration procedure at the UE 40 with the concerned public user identity related to the new event package. In steps 19 to 24, the UE 40 triggers de-registration by sending a SIP REGISTER message with a corresponding parameter, e.g. expires=0, via the P-CSCF 30 to the S-CSCF 10 (steps 19 and 20) which responds with a SIP 200 “OK” acknowledgement (steps 21 and 22). Then, the S-CSCF 10 initiates de-registration of the concerned public user identity at the AS 60 by forwarding a SIP REGISTER message with the corresponding parameter, e.g. expires=0, to the AS 60 (step 23) which also responds with a SIP 200 “OK” acknowledgement.

As a result, by providing the new event package at the AS 60, the AS 60 is in a position to actively initiate de-registration of subscribers or user identities.

There shall be three different registration cases available for AS-services: First, the end-user may use only one IMS public identity for all services (IMS and AS-services; or just IMS or AS-services). Second, services may have their own service public identities (IMS IMPU and e.g. PoC-specific IMPU), i.e. all the identities shall be registered at once (i.e. implicitly registered IMPUs), meaning that the services are automatically activated during IMS registration when the terminal is turn-on, or in the third case the AS-specific IMPU may be registered after IMS registration is done when user activates the service by selecting it from terminal's menu. In all these cases the AS registration is 3GPP release 5 compliant 3^{rd} party registration.

It is up-to operator's choice, if the AS-specific IMPUs are the chosen option. From end-user's point of view, it may be conflicting to have several public identities in use. As an example, the business cards may look a bit funny, if there are several IMPUs listed, e.g. one for each service.

However, when forced deregistration is supported in case there is just one IMPU to use or if there is a set of implicitly registered IMPUs, there might be problems to use several AS-services. For example if an error occurs in the AS-server, which leads to an AS originating forced deregistration, it shall deregister all the user's implicitly registered IMPUs. In both cases this would lead to the serious problem that the user has no access to IMS.

The worst scenario is that above problem in AS-services can always deregister the subscriber, once the terminal has requested an IMS-registration. This would mean that this AS-specific problem could prevent the user from making and receiving IMS calls until the problem is solved, in case just one IMPU or a set of implicitly registered IMPUs is used.

In the following, an enhancement according to the third embodiment of the invention is described, where the UE 40 does not accept the proposed AS-specific forced deregistration of the subscriber or a specific Public User Identity, when the user has only one implicitly registered IMPU stored into the UE 40. Because the IMPU is belonging to an implicitly registered set of IMPUs or this is the user's only IMPU, the UE 40 shall not deregister it. Despite of that the AS 60 removes the user's services and the UE 40 hides that AS-service specific items from the menu. In particular, the UE 40 does not support the forced deregistration of the subscriber or a specific Public User Identity by the AS 60. To achieve this, the UE 40 is configured to determine whether there is only one IMPU or set of implicitly registered IMPUs in use.

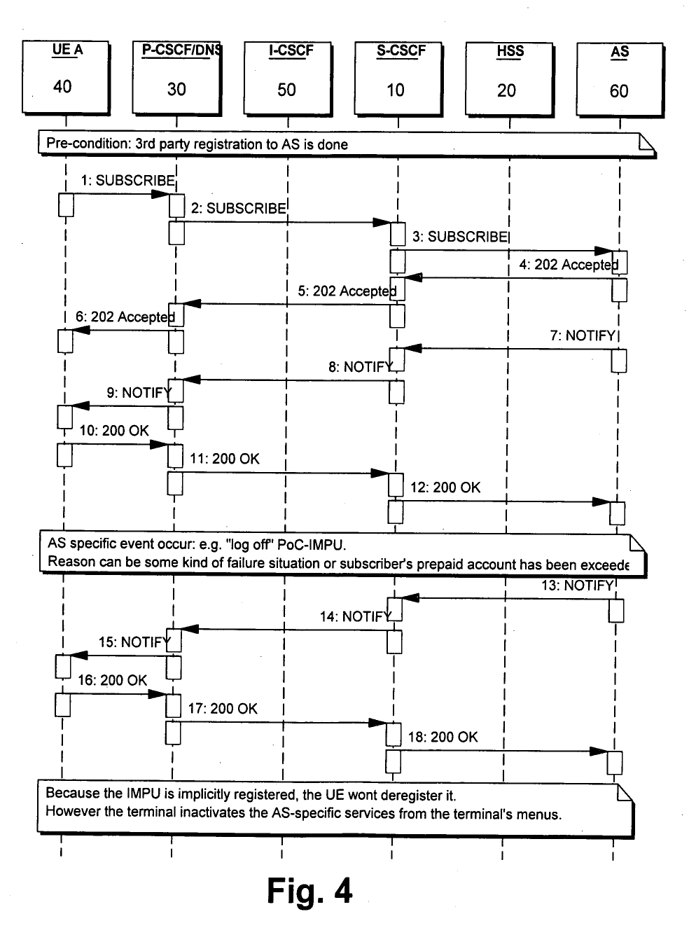

FIG. 4 shows a schematic signaling diagram of an AS-specific forced deregistration with the enhanced terminal function according to the third embodiment. As a pre-condition, a third party registration is been done to the AS 60. In steps 1 to 3, the UE 40 subscribes to the new event package (Event=“PTT service status”). Then, in steps 4 to 6, the AS 60 sends the a SIP 202 “Accepted” message. The response merely indicates that the subscription has been understood. In the following steps 7 to 9, the AS 60 sends immediately the current state of the new event package with a NOTIFY message (e.g. state=active, event=logon). The UE 40 acknowledges in steps 10 to 12 with a SIP 200 “OK” message.

When an AS specific event occurs, such as a “log offt” PTT-IMPU due to some kind of failure situation or exceeding of the subscriber's prepaid account, the AS 60 denies the service for the subscriber with the AS specific Public User Identity (IMPU) and informs this by sending a new NOTIFY message in steps 13 to 15 with a new state information (e.g. state=terminated, event=logoff). The UE 40 responds in steps 16 to 18 with a SIP 200 “OK” message. However, when there is only one IMPU stored to the terminal, the UE 40 will not accept the AS-specific forced deregistration of the subscriber or a specific Public User Identity. In the present case, the UE 40 determines that the IMPU is the user's only IMPU or it may belong to implicitly registered set of IMPUs, and will not deregister it. However, the UE 40 deactivates or inactivates the AS-specific services from the UE's menus. Thus, the AS 60 removes the user's services and the UE 40 hides them from it's menu.

The above enhanced procedure according to the third preferred embodiment provides the advantage that the user may still have access to IMS-services even if there is only an implicitly registered set of IMPUs or just one IMPU to use and an AS-originating forced deregistration has happened. E.g., the above described long-term problem in AS-services cannot prevent the user to make and receive IMS calls. This enhanced feature can be part of any PoC terminal's function, but is applicable also for other AS-concepts as well.

It is noted that the present invention is not restricted to the preferred embodiments described above. The present invention may be implemented in any data network, where a subscription to a event package can be implemented to thereby inform a subscriber of a service-related information, e.g. a service-related state and/or a service configuration. The embodiments may thus vary within the scope of the attached claims.

What is claimed is:

1. A method of forwarding a service-related information from an IP-based network to a network user, said method comprising the steps of:
providing at least one of at an IP-based network a first event package related to a service configuration and at an application server a second event package directed to a de-registration state of a network user;
initiating a subscription of said network user to at least one of said first service-related event package and said second service-related event package; and
transmitting a notification informing about at least one of said service configuration and said de-registration from at least one of said IP-based network and said application server to said network user in response to said subscription initiation.

2. A method according to claim 1, wherein said providing step comprises providing said IP-based network said first event package offered by a session control device assigned to a terminal device of said network user, and wherein said initiating step comprises initiating said subscription by said terminal device to said session control device.

3. A method according to claim 2, wherein said initiating step comprises initiating said subscription by said terminal device to said session control device comprising a service call state control function of an Internet Protocol Multimedia Subsystem network.

4. A method according to claim 1, wherein said providing step comprises providing said IP-based network said first event package offered by a default server, and wherein said initiating step comprises initiating said subscription by a terminal device of said network user to said default server.

5. A method according to claim 1, wherein said step of initiating is performed after a successful registration procedure of a terminal device of said network user.

6. A method according to claim 2, wherein said initiating step comprises storing service-related information at said terminal device to allow said network user to make use of said service-related information.

7. A method according to claim 1, wherein said initiating step comprises initiating said subscription of said second service-related event package to said application server.

8. A method according to claim 7, wherein said initiating step comprises initiating said subscription by forwarding a Session Initiation Protocol Subscribe request from a terminal device of said network user towards said application server.

9. A method according to claim 7, wherein said initiating step comprises initiating said subscription after a successful registration of said network user to said application server.

10. A method according to claim 8, further comprising the step of subjecting said Session Initiation Protocol Subscribe request to at least one filter criterion at a session control device.

11. A method according to claim 7, wherein said transmitting step comprises transmitting said notification from said application server towards a terminal device of said network user in response to an occurrence of a specific event at said application server.

12. A method according to claim 11, wherein said transmitting step comprises transmitting said notification in response to said occurrence of said specific event caused as a result of a failure situation or an exceeding of a prepaid account.

13. A method according to claim 8, wherein said providing step comprises providing said application server comprising a Push To Talk server.

14. A method according to claim 1, wherein said transmitting step comprises transmitting said notification in a Session Initiation Protocol Notify message to said network user.

15. A method according to claim 1, wherein said providing step comprises providing said IP-based network comprising a Session Initiation Protocol network.

16. A network device for serving a network user in a data network, said network device being configured to store an event package directed to a service configuration of said network user, and to transmit a notification with a service configuration information towards said network user in response to a subscription of said network user to said service-related event package.

17. A network device according to claim 16, wherein said service-related information comprises a service configuration.

18. A network device according to claim 16, wherein said network device comprises a call state control function of an Internet Protocol Multimedia Subsystem network.

19. A network device according to claim 16, wherein said network device comprises a default server.

20. An application server for providing at least one service application to a network user, said application server being configured to offer at least one of at least one event package directed to a service configuration and a de-registration state of said network user, and to forward a notification informing about at least one of said service configuration and said de-registration towards said network user in response to a subscription of said network user to said at least one event package.

21. An application server according to claim 20, wherein said application server is configured to forward said service-related information in a Session Initiation Protocol Notify message.

22. An application server according to claim 20, wherein said application server comprises a Push-to-Talk server or a Push-over-Cellular server.

23. An application server according to claim 20, wherein said application server is configured to forward said notification in response to an occurrence of a specific event at said application server.

24. An application server according to claim 23, wherein said specific event is caused as a result of a failure situation or an exceeding of a prepaid account.

25. A terminal device for providing a connection to a service application of an IP-based network, wherein said terminal device is configured to initiate a subscription to at least one of at least one event package directed to a service configuration and a de-registration state of said terminal device in response to a successful registration to said IP-based network.

26. A terminal device according to claim 25, wherein said terminal device is configured to initiate said subscription by transmitting a session Session Initiation Protocol Subscribe message to at least one of a session control device, a default server and an application server.

27. A terminal device according to claim 25 or 26, wherein said terminal device (40) is configured to determine whether the subscriber has stored only one user identity, and to reject a forced deregistration of said subscriber or of a specific user identity in response to the determination result.

28. A terminal device according to claim 27, wherein said terminal device (40) is configured to hide said implicitly registered set of IMPUs or said just one IMPU in response to said forced deregistration.

29. A system for forwarding a service-related information to a network user, said system comprising a terminal device for providing a connection to a service application of an IP-based network, wherein said terminal device is configured to initiate a subscription to at least one of at least one event package directed to a service configuration and a de-registration state of said terminal device in response to a successful registration to said IP-based network.

30. A system for forwarding a service-related information to a network user, said system comprising an initiating means for initiating a subscription by transmitting a Session Initiation Protocol Subscribe message to at least one of a session control device, a default server and an application server.

31. A system for forwarding a service-related information from an IP-based network to a network user, said system comprising:
providing means for providing at least one of at an IP-based network a first event package related to a service configuration and at an application server a second event package directed to a de-registration state of a network user;
initiating means for initiating a subscription of said network user to at least one of said first event package and said second event package; and
transmitting means for transmitting a notification informing about at least one of said service configuration and said de-registration from at least one of said IP-based network and said application server to said network user in response to said subscription initiation.
